(19) United States
(12) Patent Application Publication
(10) Pub. No.: US 2026/0078024 A1
(43) Pub. Date: Mar. 19, 2026

(54) USE OF BUBBLES WITH POROUS POLYMER ADSORBENT FOR PFAS REMOVAL FROM WATER

(71) Applicant: The Government of the United States of America, as represented by the Secretary of the Navy, Arlington, VA (US)

(72) Inventors: Meghanne E. Tighe, Falls Church, VA (US); Hunter O. Ford, Falls Church, VA (US); Matthew D. Thum, Annapolis, MD (US); Grant C. Daniels, Burke, VA (US)

(73) Assignee: The Government of the United States of America, as represented by the Secretary of the Navy, Arlington, VA (US)

(21) Appl. No.: 19/250,757

(22) Filed: Jun. 26, 2025

Related U.S. Application Data
(60) Provisional application No. 63/696,574, filed on Sep. 19, 2024.

(51) Int. Cl. C02F 1/24; C02F 1/28; C02F 101/36

(52) U.S. Cl. CPC C02F 1/24; C02F 1/285; C02F 2101/36

(57) ABSTRACT

A method of removing PFAS from water by providing a mixture of a porous material, water, and optionally a per- or poly-fluoro alkyl substance and adding gas bubbles to the mixture to form a foam having a portion of the PFAS. The porous material is made by copolymerizing a poly(ethylene glycol) acrylate with an acrylate monomer. The acrylate monomer has a functional group that interacts with an anionic group, a cationic group, or a perfluoroalkyl group.

### REFERENCE TO RELATED APPLICATIONS

This application claims the benefit of U.S. Provisional Application No. 63/696,574, filed on Sep. 19, 2024. The provisional application and all other publications and patent documents referred to throughout this nonprovisional application are incorporated herein by reference.

### TECHNICAL FIELD

The present disclosure is generally related to per- and poly-fluoro alkyl substance decontamination.

### DESCRIPTION OF THE RELATED ART

Per and poly-fluoroalkyl substances (PFAS) are an environmental contaminant of rapidly growing concern in recent decades. PFAS are a class of chemicals containing a hydrophobic fluorinated chain accompanied by a hydrophilic end group.¹ As these compounds possess very desirable properties for many applications they are used in many industries and have made their way into a multitude of consumer products and ultimately into the environment.²⁻⁷ Due to the nature of the carbon fluorine bond they also do not degrade easily and, without intervention, can persist in the environment for thousands of years. Unsurprisingly, PFAS have been measured in water⁸ and soil^{9, 10} samples all over the world due to their widespread use. Because of this, methods for removing PFAS from the environment need to be thoroughly developed.

The most common methods for PFAS capture are using activated carbon or ion exchange resins.¹¹ Each have their own advantages and disadvantages. Specifically, activated carbon is highly advantageous due to its low cost, however, it preferentially captures long chain PFAS (carbon chain≥7) over short chain PFAS (carbon chain≤6).¹² This is especially problematic because in recent years two long chain PFAS, perfluorooctanoic acid (PFOA) and perfluorosulfonic acid (PFOS), have become strictly regulated and in response industries switched to greater production of shorter chain PFAS as a replacement.¹³ Alternatively, ion exchange resins are able to capture both short and long chain PFAS, however, they must be used under very specific conditions.^{11, 14} For best performance ion exchange resins typically require carefully controlled pH and filtration flow rate, and are strongly impacted by the presence of other ions in the water.¹¹ Lastly, both ion exchange resins and activated carbon work best in a flow through filtration system which requires extensive engineering to implement, especially on a large scale.

An alternative to these is aminated polymers. Aminated polymers have a lot of promise due to their high degree of tailorability which can be used to capitalize on both hydrophobic binding sites from the polymer backbone as well as electrostatic binding sites from the amines. Aminated sorbents have been found to have superior adsorption capacity and kinetics when compared to traditional PFAS removal methods.^{15, 16} Additionally, aminated polymers can be modified to use over a broad range of pH eliminating the need for some solution processing before PFAS capture.

A different route that does not typically use any sorbent for PFAS removal is foam fractionation. Foam fractionation is an established method for removing surface active compounds from water that involves using air bubbles to create a foam layer and then physically removing the foam layer from the surface of the water.¹⁷ As PFAS are known to gravitate toward air/water interfaces in order to decrease the surface tension caused by their hydrophobic tail, foam fractionation has been shown to be effective for removing PFAS from a wide variety of samples, such as aqueous firefighting foams (AFFF),¹⁸ landfill leachate,¹⁹ and ground water.²⁰ Overall, foam fractionation is a highly advantageous technique due to its simplicity, low operation cost, and it is generally not as negatively impacted by matrix interferences as traditional adsorption methods.^{17, 21} However, foam fractionation requires careful optimization of air flow rate, continuous skimming of the foam surface layer, and generates a concentrated solution of PFAS that still needs to be further processed either through filtration or destruction techniques.²¹

A previously studied polyHIPE functionalized with quaternary amine showed potential as a PFAS adsorbent. As polyHIPEs have a microporous structure, they are filled with air pockets and will float to the air/water interface when placed in water. There have been studies that have shown increases in PFAS adsorption capacity and capture rates on various sorbents when bubbles are introduced through sonication or other means.²²⁻²⁶

### SUMMARY OF THE INVENTION

Disclosed herein is a method comprising: providing a mixture comprising: a porous material, water and optionally a per- or poly-fluoro alkyl substance and adding gas bubbles to the mixture to form a foam comprising at least a portion of any of the per- or poly-fluoro alkyl substance. The porous material is made by a process comprising: copolymerizing a poly(ethylene glycol) acrylate with a first acrylate monomer. The first acrylate monomer comprises a first functional group that interacts with a third functional group having a third functional group type selected from anionic groups, cationic groups, and perfluoroalkyl groups.

### BRIEF DESCRIPTION OF DRAWINGS

A more complete appreciation will be readily obtained by reference to the following Description of the Example Embodiments and the accompanying drawings.

FIG. 1 shows example components of a polymerized high internal phase emulsion (polyHIPE).

FIG. 2 shows a depiction of the experimental set up. The polyHIPEs are white in real life but are shown in black in this illustration for clear distinction from the bubbles.

FIG. 3 shows SEM images of the polyHIPE at different magnifications.

FIGS. 4A-B show percent PFAS removal over time with 1 gram of polyHIPE and (FIG. 4A) no bubbles and (FIG. 4B) bubbles at 1 L/min air flow. The starting solution contained 100 ppb of each PFAS.

FIG. 5 shows a comparison of the percent PFAS removal after one hour of exposure to the polyHIPE without bubbles and with bubbles at 1 L/min air flow.

FIG. 6 shows the results of a bubbling experiment without the presence of polyHIPEs.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is the use of polymerized high internal phase emulsions (polyHIPEs) with the assistance of air bubbles to facilitate the rapid removal of per- and polyfluoroalkyl substances (PFAS) from water. PFAS are known to gravitate towards air/water interfaces due to their hydrophobic tail and hydrophilic end group. As such, air bubbles have been known to facilitate PFAS transport and can create a foam layer on the surface of PFAS contaminated water. Due to the microporous structure of the polyHIPEs synthesized herein, they float to the air/water interface. It was found that the use of bubbles significantly increased total PFAS capture by the polyHIPEs and greatly increased the capture rates of each compound. When air was blown into the water sample at 1 L/min, the polyHIPE captured >99% of 10 of the 12 PFAS measured and 90% of the total PFAS in solution in one hour. When no bubbles were blown into the samples, the polyHIPEs only captured 30% of the total PFAS in solution in one hour. The addition of air bubbles also dramatically increased the capture of the short chain (≤6 carbons) PFAS. With the addition of air bubbles, the polyHIPE captured 80% of the short chain PFAS in one hour, while without bubbles the polyHIPE only captured 8% of the short chain PFAS. The use of air bubbles with the polyHIPEs led to very fast PFAS capture and greatly increased the total capture of short chain PFAS.

In a first step of the method, a mixture is provided that comprises a porous material, water, and optionally, a per- or poly-fluoro alkyl substance. The PFAS is optional because it may not be known whether the water to be decontaminated actually contains any PFAS.

The porous material is a copolymer made by copolymerizing one or more poly(ethylene glycol) acrylates with a first acrylate monomer. The first acrylate monomer comprises a first functional group that may be, for example, amine, quaternary amine, hydrogen, alkyl, thiol, cyclic alkyl, alkyl sulfonate, alkyl fluorocarbon, or aromatic fluorocarbon. The first functional group interacts with a third functional group that may be found in PFASs, such as anionic groups, cationic groups, and perfluoroalkyl groups. This interaction helps to remove the PFAS from the water.

Optionally, the copolymerization includes a second acrylate monomer that comprises a second functional group that may be, for example, amine, quaternary amine, hydrogen, alkyl, thiol, cyclic alkyl, alkyl sulfonate, alkyl fluorocarbon, or aromatic fluorocarbon. The second functional group interacts with a fourth functional group that may be found in PFASs, such as anionic groups, cationic groups, and perfluoroalkyl groups. The third and fourth functional group types are of different types, which allows for two different interactions that capture the PFAS and may allow for greater capture rates.

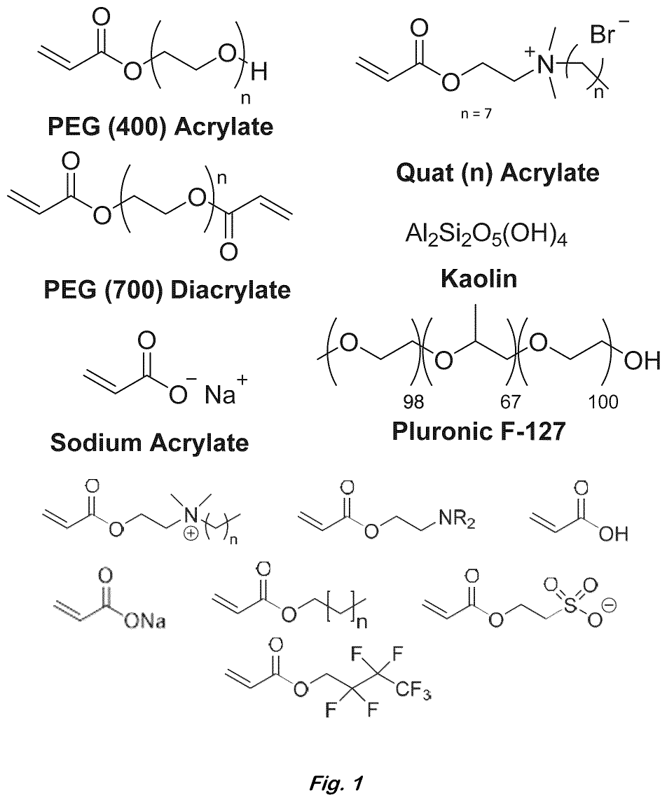

Example acrylate monomers are shown in FIG. 1. In these compounds, n is a positive integer and R is an organic group. In one example, the copolymerization includes poly(ethylene glycol) methacrylate, a poly(ethylene glycol) diacrylate, sodium acrylate, and N,N-dimethyl-N-[2-[(1-oxo-2-propen-1-yl)oxy]ethyl]-1-octanaminium bromide. Sodium acrylate contains an anionic group for interacting with a cationic group of a PFAS. The octanaminium bromide compound contains a cationic group for interacting with an anion group of a PFAS. The copolymerization may be performed by high internal phase emulsion polymerization in order to produce a porous material. Other methods of producing the material in porous form may also be used.

Example PFASs that may be present in the water include, but are not limited to, perfluorooctanoic acid, perfluorooctane sulfonic acid, a perfluoroalkyl carboxylic acid, a perfluoroalkyl sulfonic acid, a perfluoroalkyl ether acid, or a fluorotelomer sulfonate. A fluorotelomer sulfonate has a non-fluorinated alkylene group between a per- or poly-fluoroalkyl group and a sulfonate group.

Other suitable acrylates and PFASs are disclosed in US Pat. Appl. Pub. No. 2025/0066524.

The decontamination is performed by adding gas bubbles, such as air bubbles to the mixture to form a foam. At least a portion of any PFAS that is present in the water is thereby transferred from the water to the foam. One suitable way to add the bubbles is by an aerator that is submerged in the mixture. The foam may than be removed or skimmed from the mixture to leave behind water with a reduced amount of PFAS.

Incorporating bubbles can dramatically improve the capture efficiency and rates of short chain PFAS present in solution which most sorbent materials fail to capture. This method is highly advantageous due to its simplicity and low cost. The polymer is very inexpensive to synthesize and incorporating air bubbles into solution is also inexpensive and easy to operate. This method due to its simplicity could be employed in a wide variety of settings, making it very versatile in the samples it can treat. Many water plants possess the ability to do foam fractionation and already have a set up that could be conducive to this method. However, this method could also easily be implemented in a contaminated watershed or superfund site that would be much simpler to employ than any method that requires filtration.

The following examples are given to illustrate specific applications. These specific examples are not intended to limit the scope of the disclosure in this application.

Materials—Sodium acrylate, sodium chloride, pluronic F 127, poly(ethylene glycol) diacrylate (PEGDA, Mₙ=700), poly(ethylene glycol) methacrylate (PEGMA, Mₙ=400), tetramethylethylenediamine (TMeDA), ammonium persulfate, perfluoropropionic acid (PFPrA), perfluorobutanoic acid (PFBA), perfluorobutane sulfonic acid (PFBS), perfluoropentanoic acid (PFPeA), perfluoroheptanoic acid (PFHpA), perfluorononanoic acid (PFNA), perfluorodecanoic acid (PFDA), 6:2 fluorotelomer sulfonic acid (6:2 FTS), and acetonitrile were obtained from Sigma Aldrich. Formic acid, kaolin, hexanes, and tetrahydrofuran (THF) were obtained from Fisher Scientific. Perfluorooctane sulfonic acid (PFOS), perfluorohexanoic acid (PFHxA), and hexafluoropropylene oxide-dimer acid (HFPO-DA) were obtained from Matrix Scientific. Perfluorooctanoic acid (PFOA) was obtained from 3M.

Quaternary amine synthesis—10.0 g dimethylaminoethyl acrylate (DMAEA, 70 mmol), 1.05 eq of the desired bromoalkane and 30 mL of MeCN was added to a 100 mL round bottom flask equipped with a stirrer. The flask was sealed with a rubber septum and stirred at RT for 72 hrs. The solvent was removed under reduced pressure and the resulting product washed with Et₂O and dried overnight at room temperature.

PolyHIPE synthesis—Sodium acrylate (1.71 g), pluronic F 127 (0.80 g), PEGDA (9.1 mL), PEGMA (2.8 mL), kaolin (2.63 g), C8 quaternary amine acrylate (4.8 g), ammonium persulfate (2.10 g) and 14 mL of DI water were combined and vortexed until well dispersed. Next 70 mL of hexanes was added in increments, vortexing to mix after each 10 mL addition. The emulsion was then put in a speed mixer at ˜3000 rpm for 5 minutes. Then approximately 1 mL of TMEDA was added to catalyze the polymerization. After polymerization the polyHIPEs were placed in an oven overnight at 60° C. to remove the hexanes.

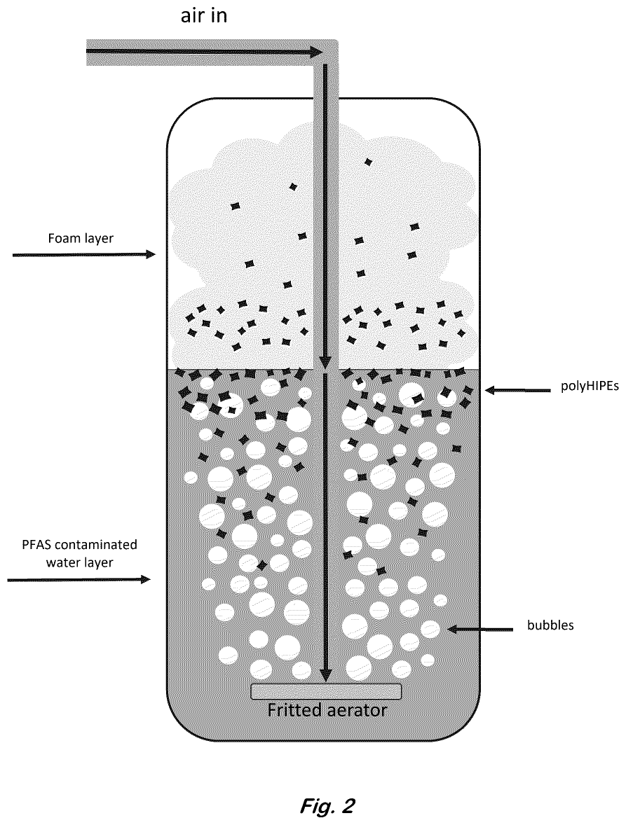

PFAS adsorption—One gram of polyHIPE was ground into small pieces using a mortar and pestle. A 250 mL solution containing 100 ppb of each of the 12 PFAS listed in Table 1 (1.2 ppm total PFAS concentration) was added to a bubbler with a fritted aerator and the polyHIPE pieces were added to the solution. A schematic of the experimental set up can be seen in FIG. 2. Air bubbles were blown into the solution at 1 L/min using an air tank and a gas flow meter to monitor the flow rate. Samples were collected by pipetting 1 mL of solution directly from the water into a vial at various time points to monitor the PFAS concentration in solution over time. The samples were then analyzed directly with LC-MS/MS without any preconcentration.

TABLE 1
PFASs used with their acronym and chemical structure

| Name | CAS # | Formula | Acronym | Chemical Structure |
|---|---|---|---|---|
| Perfluoropropionic acid | 422-64-0 | C₃HF₅O₂ | PFPrA | 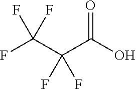 |
| Perfluorobutanoic acid | 375-22-4 | C₄HF₇O₂ | PFBA | 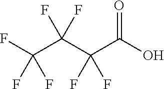 [SMILES: O=C(O)C(F)(F)C(F)(F)C(F)(F)F] |
| Perfluoropentanoic acid | 2706-90-3 | C₅HF₁₁O₂ | PFPeA | 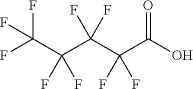 [SMILES: O=C(O)C(F)(F)C(F)(F)C(F)(F)C(F)(F)F] |
| Perfluorohexanoic acid | 307-24-4 | C₆HF₁₁O₂ | PFHxA | 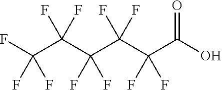 [SMILES: O=C(O)C(F)(F)C(F)(F)C(F)(F)C(F)(F)C(F)(F)F] |
| Perfluoroheptanoic acid | 375-85-9 | C₇HF₁₅O₂ | PFHpA | 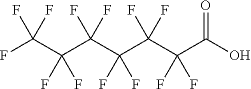 [SMILES: O=C(O)C(F)(F)C(F)(F)C(F)(F)C(F)(F)C(F)(F)C(F)(F)F] |
| Perfluorooctanoic acid | 335-67-1 | C₈HF₁₅O₂ | PFOA | 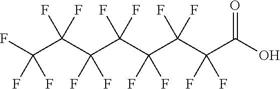 [SMILES: O=C(O)C(F)(F)C(F)(F)C(F)(F)C(F)(F)C(F)(F)C(F)(F)C(F)(F)F] |
| Perfluorononanoic acid | 375-95-1 | C₉HF₁₇O₂ | PFNA | 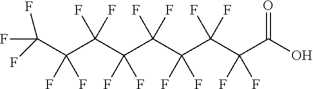 [SMILES: O=C(O)C(F)(F)C(F)(F)C(F)(F)C(F)(F)C(F)(F)C(F)(F)C(F)(F)C(F)(F)F] |
| Perfluorodecanoic acid | 335-76-2 | C₁₀HF₁₉O₂ | PFDA | 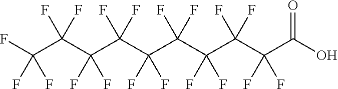 [SMILES: O=C(O)C(F)(F)C(F)(F)C(F)(F)C(F)(F)C(F)(F)C(F)(F)C(F)(F)C(F)(F)C(F)(F)F] |
| Hexafluoropropylene oxide-dimer acid | 13252-13-6 | C₆HF₁₁O₃ | HFPO- DA | 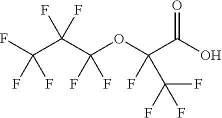 [SMILES: O=C(O)C(F)(OC(F)(F)C(F)(F)C(F)(F)F)C(F)(F)F] |
| Perfluorobutane sulfonic acid | 375-73-5 | C₄HF₉SO₃ | PFBS | 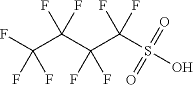 [SMILES: O=S(=O)(O)C(F)(F)C(F)(F)C(F)(F)C(F)(F)F] |
| Perfluorooctane sulfonic acid | 1763-23-1 | C₈HF₁₇SO₃ | PFOS | 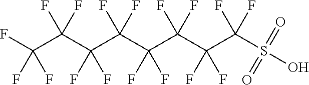 [SMILES: O=S(=O)(O)C(F)(F)C(F)(F)C(F)(F)C(F)(F)C(F)(F)C(F)(F)C(F)(F)C(F)(F)F] |
| 1H,1H′,2H,2H′- Perfluorooctane sulfonic acid | 27619-97-2 | C₈H₅F₁₃SO₃ | 6:2 FTS | 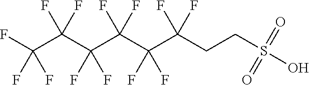 [SMILES: O=S(=O)(O)CCC(F)(F)C(F)(F)C(F)(F)C(F)(F)C(F)(F)C(F)(F)F] |

LC-MS/MS analysis—Liquid chromatography tandem mass spectrometry (LC-MS/MS) was performed on an Agilent 1260 infinity II coupled with an Ultivo LC/TQ. Calibration curves were made ranging from 0.1 ppb to 100 ppb for each PFAS. A linear fit with no weighting was used for calibration and all calibration curves returned R² values greater than 0.99.

SEM analysis—To avoid charging in the electron beam, polyHIPE samples were sputtered with about 4 nm of Au using a Denton Vacuum Desk IV Sputtering chamber. Micrographs were then collected using a Zeiss Gemini 560 FE-SEM at 10 kV, with a working distance of about 6 mm.

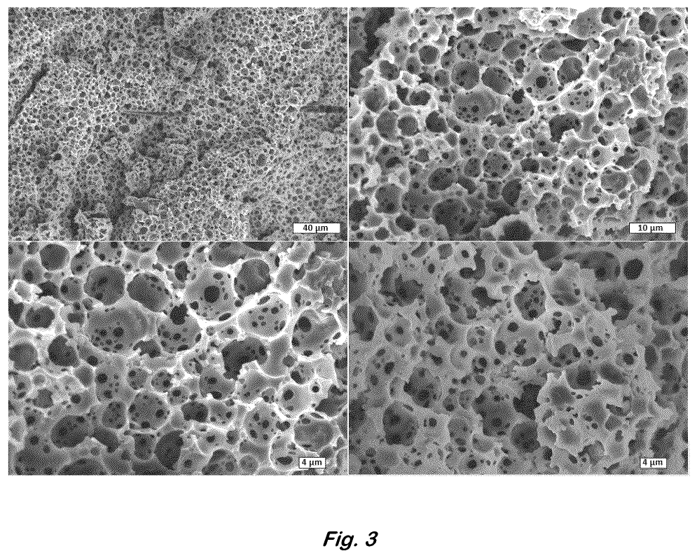

Results—The polyHIPEs were synthesized with 20 weight % C8 quaternary amine monomers. The C8 quaternary amine monomer length was chosen after a previous study showed that it created the most robust polymer system and had the highest PFAS capture. The quaternary amine content of the polymer was increased from the previous system to provide more binding sites for a higher PFAS adsorption capacity. SEM images of the quaternary amine functionalized polyHIPE used in this study are shown in FIG. 3.

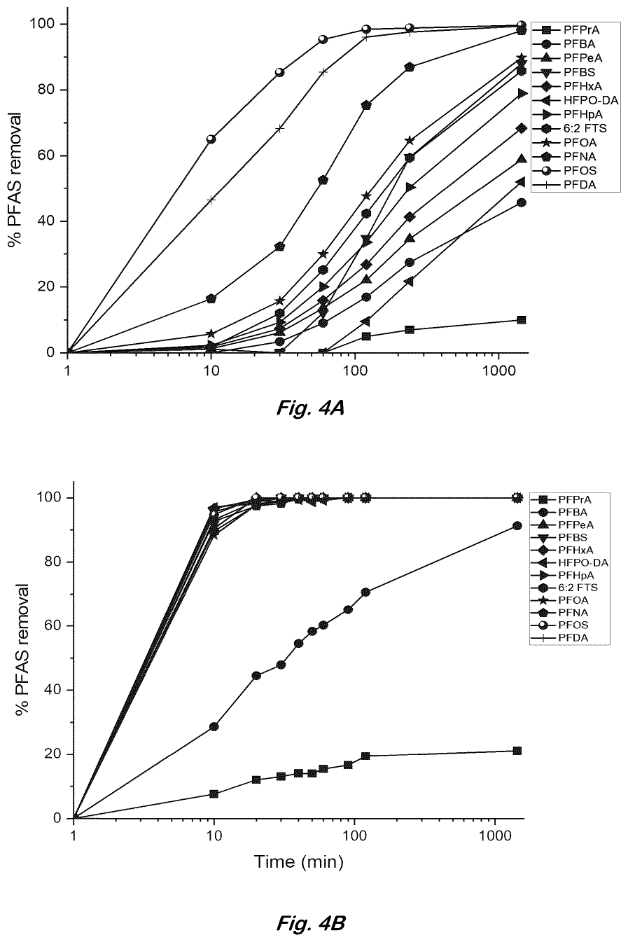

PFAS adsorption rates were determined for the polyHIPE sample by adding 1 gram of finely ground polyHIPE to a solution containing 100 ppb of each of the 12 PFAS. Air was blown in to the solution at 1 L/min to create bubbles and samples of the solution were collected over time. These results can be seen in FIGS. 4A-B.

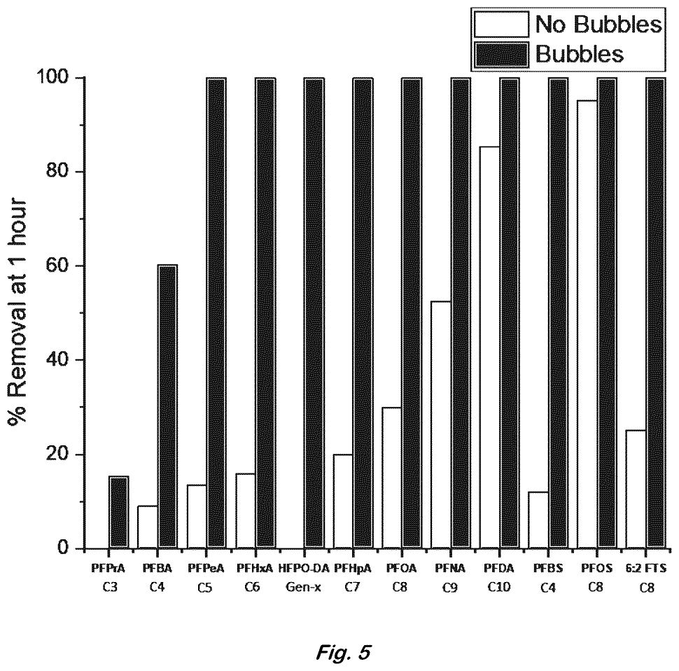

As seen in FIGS. 4A-B, with the assistance of bubbles the polyHIPE captured 10 of the 12 PFAS measured very rapidly, showing nearly complete capture in one hour. The two remaining PFAS in solution, perfluoropropionic acid (PFPrA) and perfluorobutanoic acid (PFBA), were the two shortest chain PFAS measured with carbon chain lengths of 3 and 4, respectively. These short and ultra-short chain PFAS are traditionally very hard to capture for most sorbents, so it is unsurprising that the polyHIPE did not have complete capture of these. However, after bubbling the solution for 24 hours the capture efficiency of PFBA increased to 92%. Comparatively, without the assistance of bubbles the polyHIPE was much slower to capture every PFAS in solution and had less total capture at equilibrium. This shows that the transport mechanism plays a large role in both the polyHIPE capacity for PFAS and capture rates. Using diffusion as the only transport mechanism the polyHIPE captured approximately 73% of the total PFAS in solution in 24 hours, while with the assistance of bubbles the polyHIPE captured 93% of the total PFAS in solution in the same time. This difference is even more drastic at 1 hour as with the addition of bubbles the polyHIPE captured 90% of the total PFAS in one hour, including >99% of 10 of the 12 PFAS in solution. When no bubbles were blown into the samples, the polyHIPEs captured only 30% of the total PFAS in solution in one hour. The addition of air bubbles also dramatically increased the capture of the short chain PFAS (≤6 carbons). With the assistance of air bubbles, the polyHIPE captured 80% of the short chain PFAS in one hour, while without bubbles the polyHIPE only captured 8% of the short chain PFAS in that same amount of time. This direct comparison in PFAS removal at one hour can be seen in FIG. 5.

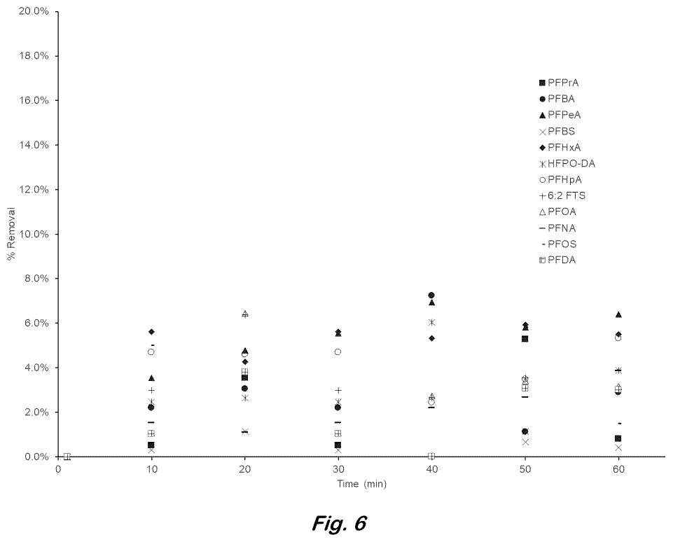

To ensure that the PFAS was being removed by the polyHIPE adsorbent and not only congregating in the foam, the experiment was repeated and all of the foam was intentionally reconstituted into the solution before collecting the samples. Compared to the previous bubbling experiment the results showed an average deviation of 3% suggesting there is no significant difference as this is within reproducibility error. Additionally, the bubbling experiment was repeated with no polyHIPEs added to solution. The results (FIG. 6) found that without the polyHIPE adsorbent <10% PFAS was removed.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

1) OECD. Reconciling Terminology of the Universe of Per- and Polyfluoroalkyl Substances: Recommendations and Practical Guidance. 2021
2) Fujii, Y.; Harada, K. H.; Koizumi, A. Occurrence of perfluorinated carboxylic acids (PFCAs) in personal care products and compounding agents. Chemosphere 2013, 93 (3), 538-544. DOI: 10.1016/j.chemosphere.2013.06.049
3) Holmquist, H.; Schellenberger, S.; van der Veen, I.; Peters, G. M.; Leonards, P. E. G.; Cousins, I. T. Properties, performance and associated hazards of state-of-the-art durable water repellent (DWR) chemistry for textile finishing. Environ Int 2016, 91, 251-264. DOI: 10.1016/j.envint.2016.02.035
4) Peaslee, G. F.; Wilkinson, J. T.; McGuinness, S. R.; Tighe, M.; Caterisano, N.; Lee, S.; Gonzales, A.; Roddy, M.; Mills, S.; Mitchell, K. Another Pathway for Firefighter Exposure to Per- and Polyfluoroalkyl Substances: Firefighter Textiles. Environ Sci Tech Let 2020, 7 (8), 594-599. DOI: 10.1021/acs.estlett.0c00410
5) Whitehead, H. D.; Venier, M.; Wu, Y.; Eastman, E.; Urbanik, S.; Diamond, M. L.; Shalin, A.; Schwartz-Narbonne, H.; Bruton, T. A.; Blum, A.; et al. Fluorinated Compounds in North American Cosmetics (vol 8, pg 538, 2021). Environ Sci Tech Let 2021, 8 (12), 1104-1105. DOI: 10.1021/acs.estlett. 1c00903
6) Schaider, L. A.; Balan, S. A.; Blum, A.; Andrews, D. Q.; Strynar, M. J.; Dickinson, M. E.; Lunderberg, D. M.; Lang, J. R.; Peaslee, G. F. Fluorinated Compounds in US Fast Food Packaging. Environ Sci Tech Let 2017, 4 (3), 105-111. DOI: 10.1021/acs.estlett.6b00435
7) Sunderland, E. M.; Hu, X. D. C.; Dassuncao, C.; Tokranov, A. K.; Wagner, C. C.; Allen, J. G. A review of the pathways of human exposure to poly- and perfluoroalkyl substances (PFASs) and present understanding of health effects. J Expo Sci Env Epid 2019, 29 (2), 131-147. DOI: 10.1038/s41370-018-0094-1
8) Domingo, J. L.; Nadal, M. Human exposure to per- and polyfluoroalkyl substances (PFAS) through drinking water: A review of the recent scientific literature. Environ Res 2019, 177. DOI: 10.1016/j.envres.2019.108648
9) Wang, Y.; Munir, U.; Huang, Q. Occurrence of per- and polyfluoroalkyl substances (PFAS) in soil: Sources, fate, and remediation. Soil & Environmental Health 2023, 1 (1). DOI: 10.1016/j.seh.2023.100004
10) Ahmed, M. B.; Johir, M. A. H.; McLaughlan, R.; Nguyen, L. N.; Xu, B. T.; Nghiem, L. D. Per- and polyfluoroalkyl substances in soil and sediments: Occurrence, fate, remediation and future outlook. Sci Total Environ 2020, 748. DOI: 10.1016/j.scitotenv.2020.141251
11) Dixit, F.; Dutta, R.; Barbeau, B.; Berube, P.; Mohseni, M. PFAS removal by ion exchange resins: A review. Chemosphere 2021, 272. DOI: 10.1016/j.chemosphere.2021.129777
12) McCleaf, P.; Englund, S.; Östlund, A.; Lindegren, K.; Wiberg, K.; Ahrens, L. Removal efficiency of multiple poly- and perfluoroalkyl substances (PFASs) in drinking water using granular activated carbon (GAC) and anion exchange (AE) column tests. Water Res 2017, 120, 77-87. DOI: 10.1016/j.watres.2017.04.057
13) Brennan, N. M.; Evans, A. T.; Fritz, M. K.; Peak, S. A.; von Holst, H. E. Trends in the Regulation of Per- and Polyfluoroalkyl Substances (PFAS): A Scoping Review. Int J Env Res Pub He 2021, 18 (20). DOI: 10.3390/ijerph182010900
14) Murray, C. C.; Marshall, R. E.; Liu, C. J.; Vatankhah, H.; Bellona, C. L. PFAS treatment with granular activated carbon and ion exchange resin: Comparing chain length, empty bed contact time, and cost. J Water Process Eng 2021, 44. DOI: 10.1016/j.jwpe.2021.102342
15) Ateia, M.; Alsbaiee, A.; Karanfil, T.; Dichtel, W. Efficient PFAS Removal by Amine-Functionalized Sorbents: Critical Review of the Current Literature. Environ Sci Tech Let 2019, 6 (12), 688-695. DOI: 10.1021/acs.estlett.9b00659
16) Chaleshtari, Z. A.; Foudazi, R. A Review on Per- and Polyfluoroalkyl Substances (PFAS) Remediation: Separation Mechanisms and Molecular Interactions. ACS EST Water 2022, 2 (12), 2258-2272. DOI: 10.1021/acsestwater.2c00271
17) Buckley, T.; Xu, X. Y.; Rudolph, V.; Firouzi, M.; Shukla, P. Review of foam fractionation as a water treatment technology. Sep Sci Technol 2022, 57 (6), 929-958. DOI: 10.1080/01496395.2021.1946698
18) Meng, P. P.; Deng, S. B.; Maimaiti, A.; Wang, B.; Huang, J.; Wang, Y. J.; Cousins, I. T.; Yu, G. Efficient removal of perfluorooctane sulfonate from aqueous film-forming foam solution by aeration-foam collection. Chemosphere 2018, 203, 263-270. DOI: 10.1016/j.chemosphere.2018.03.183
19) Smith, S. J.; Wiberg, K.; McCleaf, P.; Ahrens, L. Pilot-Scale Continuous Foam Fractionation for the Removal of Per- and Polyfluoroalkyl Substances (PFAS) from Landfill Leachate. Acs Es&T Water 2022, 2 (5), 841-851. DOI: 10.1021/acsestwater.2c00032
20) Burns, D. J.; Stevenson, P.; Murphy, P. J. C. PFAS removal from groundwaters using Surface-Active Foam Fractionation. Remediation 2021, 31 (4), 19-33. DOI: 10.1002/rem.21694
21) We, A. C. E.; Zamyadi, A.; Stickland, A. D.; O, C. B.; Freguia, S. A review of foam fractionation for the removal of per- and polyfluoroalkyl substances (PFAS) from aqueous matrices. J Hazard Mater 2024, 465. DOI: 10.1016/j.jhazmat.2023.133182
22) Meng, P. P.; Jiang, X.; Wang, B.; Huang, J.; Wang, Y. J.; Yu, G.; Cousins, I. T.; Deng, S. B. Role of the air-water interface in removing perfluoroalkyl acids from drinking water by activated carbon treatment. J Hazard Mater 2020, 386. DOI: 10.1016/j.jhazmat.2019.121981
23) Meng, P. P.; Deng, S. B.; Wang, B.; Huang, J.; Wang, Y. J.; Yu, G. Superhigh adsorption of perfluorooctane sulfonate on aminated polyacrylonitrile fibers with the assistance of air bubbles. Chem Eng J 2017, 315, 108-114. DOI: 10.1016/j.cej.2017.01.033
24) Meng, P. P.; Deng, S. B.; Lu, X. Y.; Du, Z. W.; Wang, B.; Huang, J.; Wang, Y. J.; Yu, G.; Xing, B. S. Role of Air Bubbles Overlooked in the Adsorption of Perfluorooctanesulfonate on Hydrophobic Carbonaceous Adsorbents. Environ Sci Technol 2014, 48 (23), 13785-13792. DOI: 10.1021/es504108u
25) Liu, W.; Lin, T.; Zhang, X.; Jiang, F. C.; Yan, X. S.; Chen, H. Adsorption of perfluoroalkyl acids on granular activated carbon supported chitosan: Role of nanobubbles. Chemosphere 2022, 309. DOI: 10.1016/j.chemosphere.2022.136733
26) Jiang, X. Z.; Wang, W.; Yu, G.; Deng, S. B. Contribution of Nanobubbles for PFAS Adsorption on Graphene and OH- and NH-Functionalized Graphene: Comparing Simulations with Experimental Results. Environ Sci Technol 2021, 55 (19), 13254-13263. DOI: 10.1021/acs.est.1c03022

What is claimed is:

1. A method comprising:
providing a mixture comprising:
a porous material made by a process comprising:
copolymerizing a poly(ethylene glycol) acrylate with a first acrylate monomer;
wherein the first acrylate monomer comprises a first functional group;
wherein the first functional group interacts with a third functional group having a third functional group type selected from anionic groups, cationic groups, and perfluoroalkyl groups;
water; and
optionally, a per- or poly-fluoro alkyl substance; and
adding gas bubbles to the mixture to form a foam comprising at least a portion of any of the per- or poly-fluoro alkyl substance.

2. The method of claim 1, wherein the mixture comprises the per- or poly-fluoro alkyl substance.

3. The method of claim 1, wherein the copolymerization is performed by high internal phase emulsion polymerization.

4. The method of claim 1, wherein the per- or poly-fluoro alkyl substance is a perfluoroalkyl carboxylic acid, a perfluoroalkyl sulfonic acid, a perfluoroalkyl ether acid, or a fluorotelomer sulfonate.

5. The method of claim 1, wherein the per- or poly-fluoro alkyl substance is perfluorooctanoic acid or perfluorooctane sulfonic acid.

6. The method of claim 1, wherein the first functional group is amine, quaternary amine, hydrogen, alkyl, thiol, cyclic alkyl, alkyl sulfonate, alkyl fluorocarbon, or aromatic fluorocarbon.

7. The method of claim 1 wherein the first acrylate monomer is 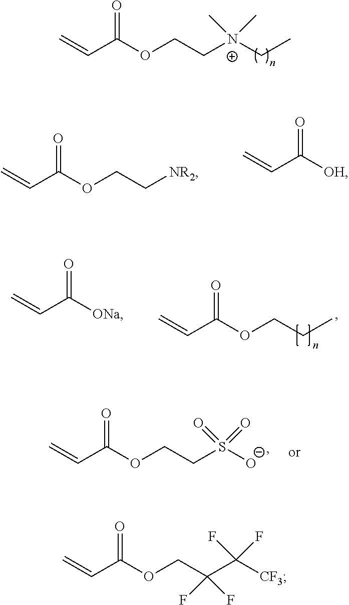
wherein n is a positive integer; and
wherein R is an organic group.

8. The method of claim 1;
wherein the copolymerization includes a second acrylate monomer;
wherein the second acrylate monomer comprises a second functional group;
wherein the second functional group interacts with a fourth functional group having a fourth functional group type selected from anionic groups, cationic groups, and perfluoroalkyl groups;
wherein the third functional group type and the fourth functional group type are different.

9. The method of claim 8;
wherein the poly(ethylene glycol) acrylate is combination of a poly(ethylene glycol) methacrylate and a poly(ethylene glycol) diacrylate;
wherein the first acrylate monomer is sodium acrylate; and
wherein the second acrylate monomer is N,N-dimethyl-N-[2-[(1-oxo-2-propen-1-yl)oxy]ethyl]-1-octanaminium bromide.

10. The method of claim 1, wherein adding gas bubbles is performed by pumping air through an aerator that is submerged in the mixture.

11. The method of claim 1, further comprising:
separating the foam from the mixture.
